(19) United States
(12) Patent Application Publication
(10) Pub. No.: US 2010/0262450 A1
(43) Pub. Date: Oct. 14, 2010

(54) METHOD AND SYSTEM FOR MOBILE ASSET MANAGEMENT

(76) Inventors: Christopher Kalish, Pleasantville, NY (US); Rohini Sen, Willington, CT (US); Sixing Chen, Stamford, CT (US); Bethany Lynne DiMarzio, Bethel, CT (US); Qiqing Wu, Stratford, CT (US); Ramesh Sankaranarayanan, Storrs, CT (US); Sudip Bhattacharjee, South Windsor, CT (US); Gain-Carlo Vellutino, Pelham, NY (US)

Correspondence Address: BUCKLEY, MASCHOFF & TALWALKAR, LLC;GENERAL ELECTRIC COMPANY, 50 LOCUST AVENUE, NEW CANAAN, CT, 06840, US

(21) Appl. No.: 12/421,764

(22) Filed: Apr. 10, 2009

(51) Int. Cl. G06Q 10/00

(52) U.S. Cl. 705/8

(57) ABSTRACT

A method and system related to managing mobile assets, the method including receiving asset event data associated with a plurality of mobile assets including information indicative of location status, motion status, and cargo status of the plurality of mobile assets; determining asset segment data defined by the asset event data of the plurality of mobile assets during a time interval based on the asset event data; determining turn time data for each of the plurality of mobile assets; calculating a set of metrics for the plurality of mobile assets based on the asset segment data and the turn time data; determining an optimal asset pool size for a location to be serviced by the plurality of mobile assets; and providing an output of the determined optimal asset pool size for the location.

### FIELD OF THE INVENTION

The present invention relates to a method, apparatus, and system for managing mobile assets.

### BACKGROUND OF THE INVENTION

Telematics, including vehicle telematics systems comprising global positioning satellite (GPS) tracking and wireless communications, may be used to perform a number of functions such as vehicle tracking, mobile communication, roadside assistance, traffic alerts, and even remote diagnostics. In some instances, a telematics system may include audio and visual entertainment applications. Typically, primary functions of these telematics systems include monitoring the status of one or more parameters, communicating the monitored status via a communication aspect of the telematics system, and performing an action in response to the status of the monitored parameter.

A continued focus of telematics systems heretofore remains the monitoring and reporting of the status of the desired parameters. That is, the collection of raw data relating to the monitored parameters is a key function and aspect of many telematics systems. While actions may be performed based on the raw data, prior telematics systems lack effective analytical tools and mechanisms. Such analytical tools would provide a mechanism for users (i.e., business managers) to better manage the monitored vehicles and systems.

Accordingly, there exists a need for a method, system, and mechanism to provide enhanced analytics to efficiently manage mobile assets, including mobile assets having telematics.

### SUMMARY OF THE INVENTION

Some embodiments of the present disclosure provide a system, method, apparatus, means, and article for managing mobile assets including telematics. A method in accordance with the present disclosure may include receiving asset event data associated with a plurality of mobile assets, the asset event data including information indicative of location status, motion status, and cargo status of the plurality of mobile assets; determining, by a computer, asset segment data for the plurality of mobile assets based on the asset event data, the asset segment data defined by the asset event data of the plurality of mobile assets during a time interval; determining, by the computer, turn time data for each of the plurality of mobile assets, the turn time data being based on the asset segment data and a user-defined delivery cycle; and calculating, by the computer, a set of metrics for the plurality of mobile assets based on the asset segment data and the turn time data. Based the set of calculated metrics an optimal asset pool size for a location serviced by the plurality of mobile assets may be determined. In some embodiments, a report of the determined optimal asset pool size may be generated and provided for review and/or further analysis.

In some embodiments herein, a system and method may further include determining errors in the received asset event data and/or asset segment data and performing further processing of the asset event data and/or asset segment data minus the determined errors.

In various aspects herein, the determined optimal asset pool size for the location is the minimum number of mobile assets required to service the location; the plurality of mobile assets comprise a fleet; and data structures are defined and provided to facilitate the calculation of the set of metrics.

The methods disclosed herein may be implemented and facilitated by a computer or other processor based machine, including but not limited to a server, a general purpose computing device, a dedicated computer, a hand held device such as a laptop, a netbook, and a smartphone. In some embodiments, the methods and systems herein may be implemented, at least in part, in a computer application or service.

In some embodiments, a method, system, and mechanism herein may provide enhanced analytics to efficiently manage mobile assets, including mobile assets having telematics. In some embodiments, enhanced efficiencies may provide better utilization of resources, cost savings, and environmentally friendlier systems and methods.

Additional objects, advantages, and novel features of the present disclosure shall be set forth in part in the description that follows, and in part will become apparent to those skilled in the art upon examination of the following or may be learned by the practice of the disclosure.

### BRIEF DESCRIPTION OF THE DRAWINGS

The accompanying drawings, which are incorporated herein and form a part of the specification, illustrate some embodiments of the present disclosure, and together with the descriptions serve to explain the principles thereof.

FIG. 1 is a block diagram illustrating a system environment for some embodiments herein;

FIG. 2 is an exemplary flow diagram of a process, in accordance with some embodiments herein; and

FIG. 3 is a table listing of data, in accordance with embodiments herein;

FIG. 4 is a table listing of data, in accordance with embodiments herein;

FIG. 5 is another listing of data relating to aspects herein;

FIG. 6 is a table organized listing of information, in accordance with embodiments herein;

FIG. 7 too is a table listing of data, in accordance with embodiments herein;

FIG. 8 is a listing of information, relating to some aspects herein;

FIG. 9 is a table, in accordance with embodiments herein;

FIG. 10 is a flow diagram, illustrating some aspects of the present disclosure; and

FIG. 11 is a table relating to exemplary data, in accordance with embodiments herein.

### DETAILED DESCRIPTION

Applicants have recognized that there is a need for methods, systems, means, and computer code that facilitate management of mobile assets associated with telematics. The mobile assets may be one or more types of mobile transportation, such as, for example, an automobile, a truck, a trailer, a shipping container, etc. In particular, applicants have recognized that there is a need for methods, systems, means, and computer code for efficiently managing mobile assets comprising a fleet by using intelligent analytics of mobile assets related data. In some aspects, analytical tools and analytics herein may provide a mechanism for users to better manage the monitored mobile assets and realize, for example, cost, user-interface, productivity, and other efficiencies.

In some embodiments, a method and system herein may be used to optimize capacity utilization of a fleet of mobile assets. The plurality of mobile assets forming the fleet may be used to carry cargo, including for example products, passengers, materials, and other goods to and from one or more locations. The mobile assets may be outfitted with state-sensing devices constituting at least part of a telematics system. The telematics system may include functionality to provide a location status, a motion status (e.g., in motion, idle, or dormant), and a cargo status (e.g., empty of cargo or loaded with cargo).

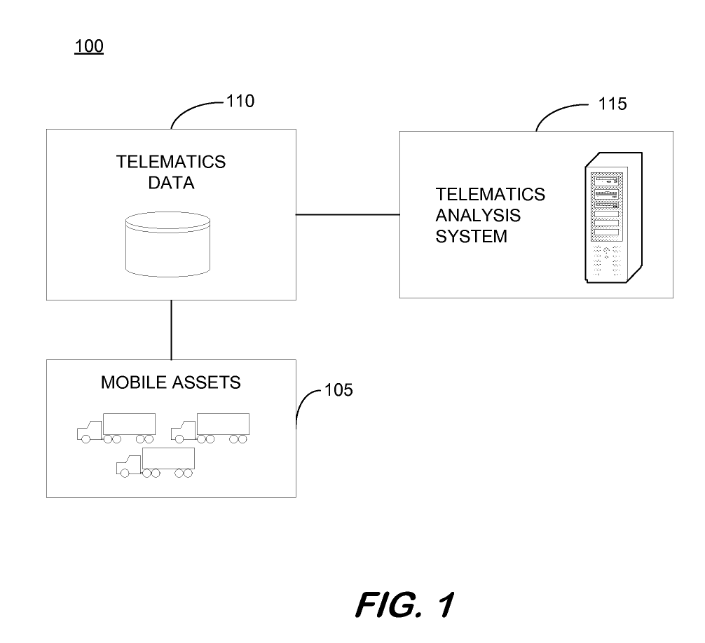

FIG. 1 is a block diagram of an exemplary system 100, in accordance with systems and methods herein. In particular, system 100 includes a fleet of mobile assets 105. Each of the plurality of mobile assets in fleet 105 may be equipped with a state-sensing device capable of communicating asset event data such as, but not limited to, a location status, a motion status, and a cargo status as a result of being part of a telematics system (not shown). The telematics system may include, for example, a hardware and/or software state-sensing device to receive GPS signals from a GPS satellite and transmit location and motion state information to a telematics communication system. The telematics communication system may include both wired and wireless communication channels to handle communication messages between the fleet 105 mobile assets and a control system or device that handles administration, data collection, and/or data storage for the telematics system. In some embodiments, the communication system is not limited to any particular communication format or protocol. In some embodiments, the telematics system herein may include, for example, the VeriWise™ system provided by the General Electric Corporation, the assignee of the present disclosure.

It is noted that the mobile asset information may include the parameters of location, motion, and cargo status. It should be appreciated that other parameters may be monitored such as, for example and without limitation, an altitude, a pressure, a temperature, an orientation, and other values associated with the plurality of mobile assets of fleet 105.

The state-sensing data or telematics data associated with fleet 105 may be stored or persisted at data store 110. Data store 110 may be a dedicated data warehouse or, for example, form part of a database system, application, or service. It is noted that the data at data store 110 may be referred to as “raw data” since it primarily represents the data values directly received and/or determined by the telematics state-sensing devices. Data store 110 may form part of the telematics system associated with mobile assets fleet 105 or be a separate distinct entity. In some instances, a primary persistence of the relevant mobile assets fleet 105 may be stored in a database and a secondary or other persistence of the relevant mobile assets fleet 105 data may be persisted at data store 110 and be available for further processing and manipulation by Telematics Analysis System (TAS) 115.

It is noted that while the communication paths between the fleet of mobile assets 105, data store 110, and TAS 115 are depicted by solid lines in FIG. 1, the communication between the various elements need not be permanent, direct, or wired communication channels. Instead, the communication paths between the various elements may be wired or wireless, routed and/or re-routed through a number of intervening networks and network devices, permanent, established on an ad-hoc, as needed, or as requested basis. Additionally, a combination of multiple communication channels, types, and protocols may be used in system 100.

TAS 115 may be used to provide analytics of the raw data generated by the telematics system related to mobile assets fleet 105. In some embodiments, mobile asset state data may be processed into summary or aggregate information to enable an analyst or user to determine a set of business valued metrics. Based on the metrics and analytics provided in an embodiment herein, one or more informed business decisions related to fleet mobile assets 105 may be made. In some embodiments, TAS 115 may be implemented to detect or otherwise determine anomalies in various aspects of data associated with mobile assets fleet 105 and optionally calculate a set of metrics without the error tainted portions of the mobile assets data.

As will be discussed in greater detail below, one approach to determine whether the mobile assets are being used to their fullest (i.e., optimal) capacity is to decrease an “idle time” of the mobile assets at the various locations visited by the mobile assets, as well as to decrease “empty transit times” during which the mobile assets are moving without a cargo or payload.

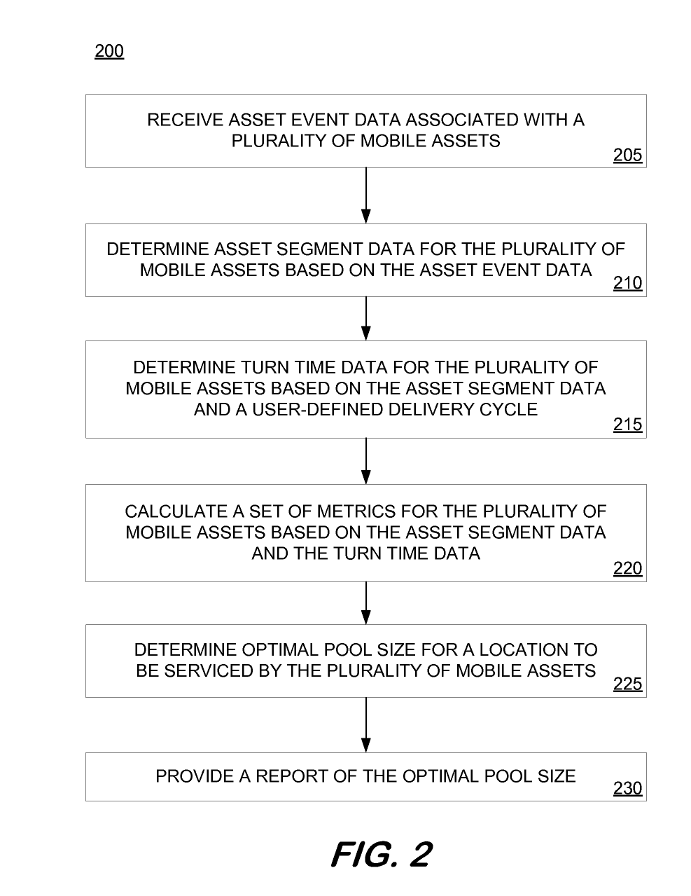

FIG. 2 is a flow chart of a method 200, in accordance with an embodiment herein. More specifically, method 200 is related to a process of determining a set of analytical metrics to facilitate the management of a fleet, pool, or plurality of mobile assets. At operation 205, asset event data associated with a plurality of mobile assets such as fleet 105 depicted in FIG. 1 is received. The asset event data may be received directly from a state-sensing device, system, or subsystem including the sensing device(s), a data store 110, a memory, or a data repository including asset event data including mobile asset status information, an indication of such data, or a pointer (e.g., an index) to such data. Further, the data may be received by a system 115, application, subsystem, device, apparatus, or service that includes functionality for executing the analytics herein.

In some embodiments, the plurality of mobile assets may refer to all or less than all of the mobile assets, fleet, or pool of monitored assets. That is, in some instances a plurality of the mobile assets may refer to a subset or set including less than all of the mobile assets.

As used herein, the asset event data refers to the collected or generated raw data corresponding to the telematics related data associated with the fleet of mobile assets. The asset event data herein may relate to a location status, a motion status, and a cargo status for a particular mobile asset at specific point in time. In some instances, the status of one or more of the location state, motion state, and cargo state may be zero or null. In such instances a value may not be presented for such zero and/or null values. However, such values may still be accounted for or understood to be zero or null and the asset event data may still be referred to as being indicative of the location, motion, and cargo status for a particular mobile asset at a specific point in time.

At operation 210, a determination is made to obtain asset segment data for the plurality of mobile assets based on the asset event data. As used herein, asset segment data relates to the location status, motion status, and cargo status for a particular mobile asset during an interval of time. That is, the asset segment data is concerned with the status of the mobile asset over a period of time.

In an example involving a fleet of tractor-trailer mobile assets operated by or on the behalf of a regional or national department store, relevant “segments” may include the seven (7) types of segments listed in the following table 1.

TABLE 1

| SEGMENT | |
|---|---|
| NAME | SEGMENT DESCRIPTION |
| TRANSIT | The time interval from one BOD to a next EOD during |
| | which a mobile asset is moving from one location to |
| | another location. |
| DC DWELL | The time interval from an EOD at a given DC location |
| | to a next BOD during which a mobile asset is idle at |
| | that DC location. |
| STORE | The time interval from an EOD at a given store location |
| DWELL | to a next BOD during which a mobile asset is idle |
| | at that store location. |
| VENDOR | The time interval from an EOD at a given vendor |
| DWELL | location to a next BOD during which a mobile |
| | asset is idle at that vendor location. |
| X-DOCK | The time interval from an EOD at a given X-Dock |
| DWELL | location to a next BOD during which a mobile asset |
| | is idle at that X-Dock location. |
| DECON | The time interval from an EOD at a given Decon location |
| DWELL | to a next BOD during which a mobile asset is idle at |
| | that Decon location. |
| NO | The time interval from an EOD with NO landmark |
| LANDMARK | name to a next BOD during which a mobile asset is idle |
| DWELL | at that unnamed location. |

Regarding Table 1, “BOD” refers to beginning of drive that indicates an event that marks the start of an in transit segment. It is noted that an in transit segment refers to an interval during which a mobile asset is moving from a first location to a second location. “EOD” refers to end of drive that indicates an event marking an end of an in transit segment. “DC” refers to a distribution center, one of the significant types of locations the mobile assets of the present example may visit or service. During an in transit time, the mobile asset may have a cargo value of empty or loaded.

It is noted that other types of segments may be defined for other examples or applications. In some embodiments, the types of segments may be defined and applicable for a particular industry or group of industries. That is, in some aspects, the asset segment types may be “standardized” for a particular business application(s) or business process(s).

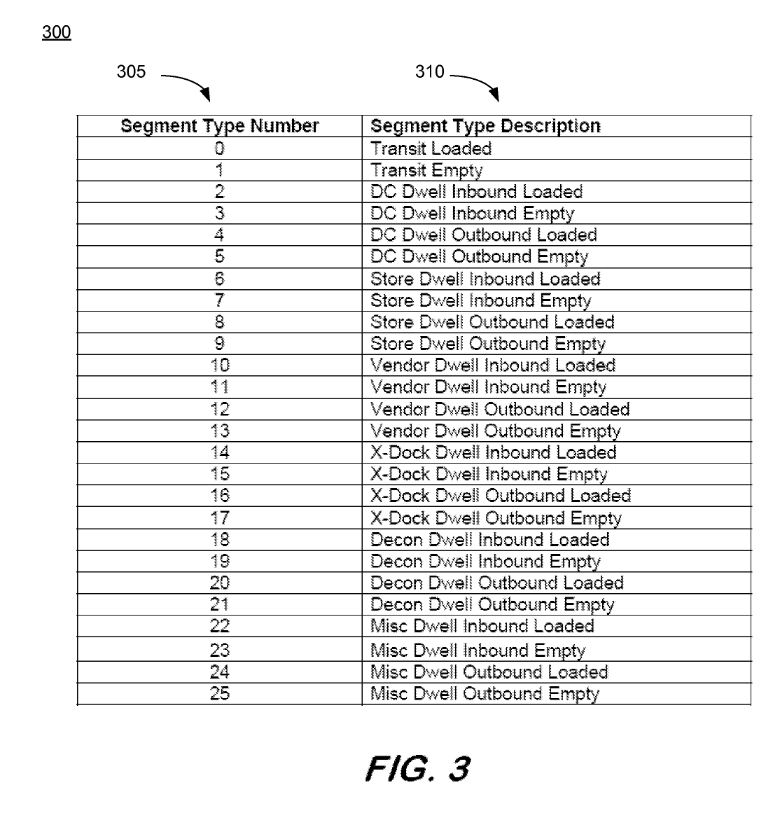

Herein, an idle time asset segment refers to a significant interval of time during which a mobile asset is one particular location. During an idle time segment, the mobile asset may have cargo value of empty or loaded. Also, the location name and type of location is provided in an indication for an idle time segment of a mobile asset. In some embodiments, a total of 26 different segment types may be identified and used in describing mobile assets states herein, as shown in FIG. 3. FIG. 3 provides a listing of 26 segment types (0-25) at 305 and the corresponding name for the segment types at 310. It is noted that the segments include a indication of location (e.g., DC, store, vendor, etc.), motion (e.g., dwell), and cargo (e.g., empty or loaded) status for each of the listed segments.

The segments may be defined based on a review or analysis of historical mobile asset data generated based on actual operation of the fleet. Based on a review of raw data associated with a fleet of mobile assets, distinct segment types may be defined using the response codes given in raw data as beginning and end points for segment times. As an example, a review of raw data may reveal a response code indicative of the beginning of a transit segment. Then, a next chronological response code for the same mobile asset may reveal a code that indicates the end of the transit segment. The time elapsed between beginning of transit and end of transit would thus define a time interval for a transit segment. Similarly, idle time segments may be determined.

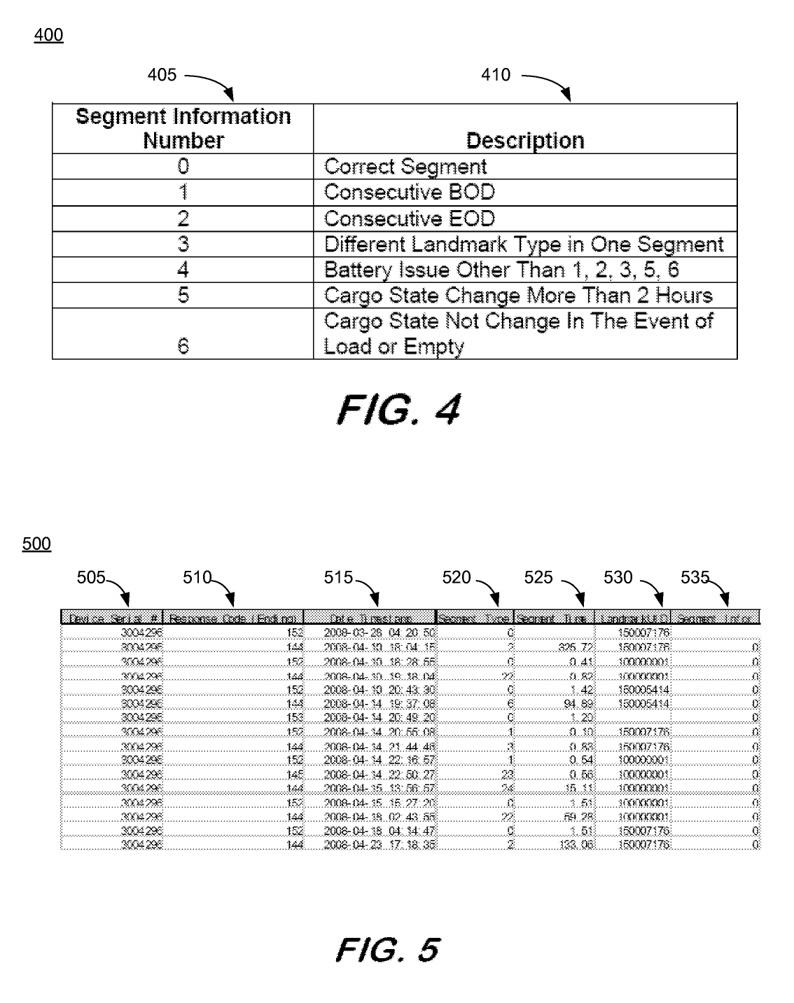

In some embodiments, error points, if any, may be determined for asset segment data. FIG. 4 includes a listing of six (6) error points 405 that may indicate the asset segment data contains an error or otherwise may not be reliable. If errors are determined to be in the asset segment data, the error containing data may be removed so that the errors are not propagated through to further calculations.

FIG. 5 provides an exemplary tabular listing 500 that includes response codes 510 indicative of a status for a particular sample mobile asset having a telematics sensing device serial number at 505. As shown, the table of FIG. 5 includes a timestamp 515, a segment type 520 (e.g., 0-25 per FIG. 3), a segment time duration 525, and a landmark identifier 530. It is reiterated that the segment type may be determined based on the mobile asset event data (i.e., raw data) including location, motion, and cargo values.

Referring again to FIG. 2, “turn time” data may be determined for a fleet of mobile assets 105 at operation 215. The turn time data may be based on both the asset segment data and a user-defined delivery cycle. As used herein, the turn time is a delivery cycle defined as the elapsed time between two user-defined events. The events may be defined by a user based on applicable considerations relevant to the use and service of the user's mobile assets. Further, business considerations may be considered in determining which events may constitute a “turn” for a particular user (e.g., an individual, a business, a particular business segment, etc.) Accordingly, the user-defined “turn times” may vary for different users, depending on the definition established and used to determine the “turn times” for the different users. In some embodiments, the number of user-defined “turn times” may also vary

Table 2 below provides a listing of user-defined turn definitions that may be used to illustrate aspects of the present disclosure.

TABLE 2

| SEGMENT NAME | SEGMENT DESCRIPTION |
|---|---|
| EOD at a Landmark | To EOD at a same landmark. |
| EOD at a Landmark | To EOD at a different landmark. |
| CL at a Landmark | To CL at same a landmark. |
| CL at a Landmark | To CL at a different landmark. |

As shown, segment data of an end of a delivery, EOD, at a same or a new landmark each comprises a turn; and the segment data indicative of the loading of cargo, CL, at a same or a different landmark may also comprise a turn according to table 2.

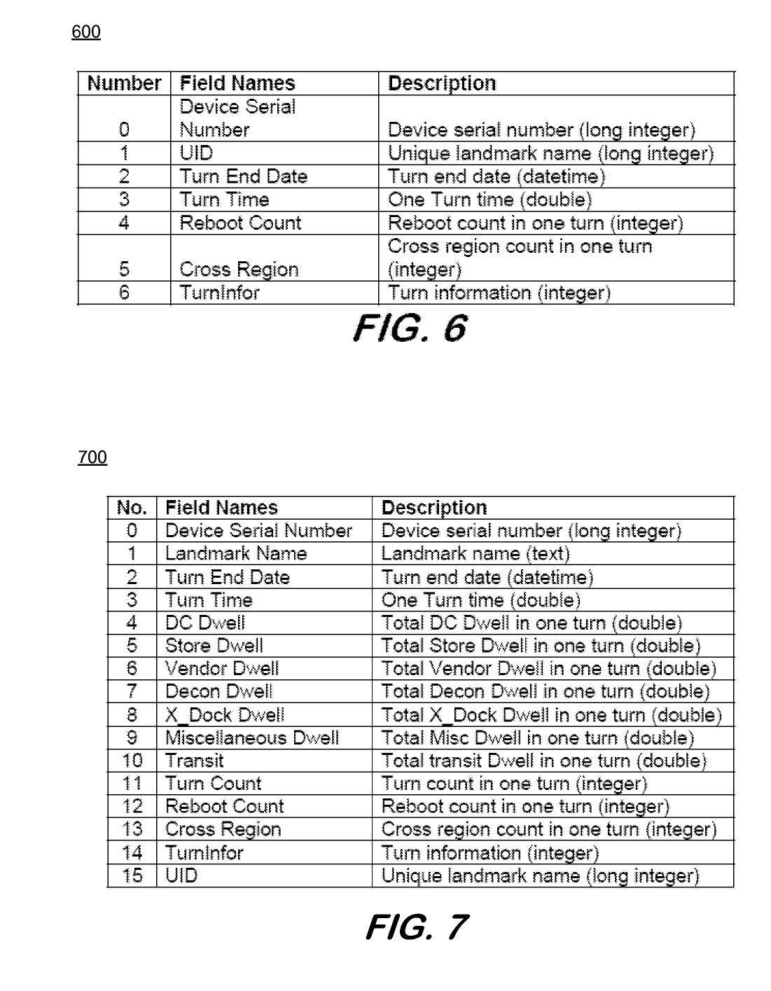

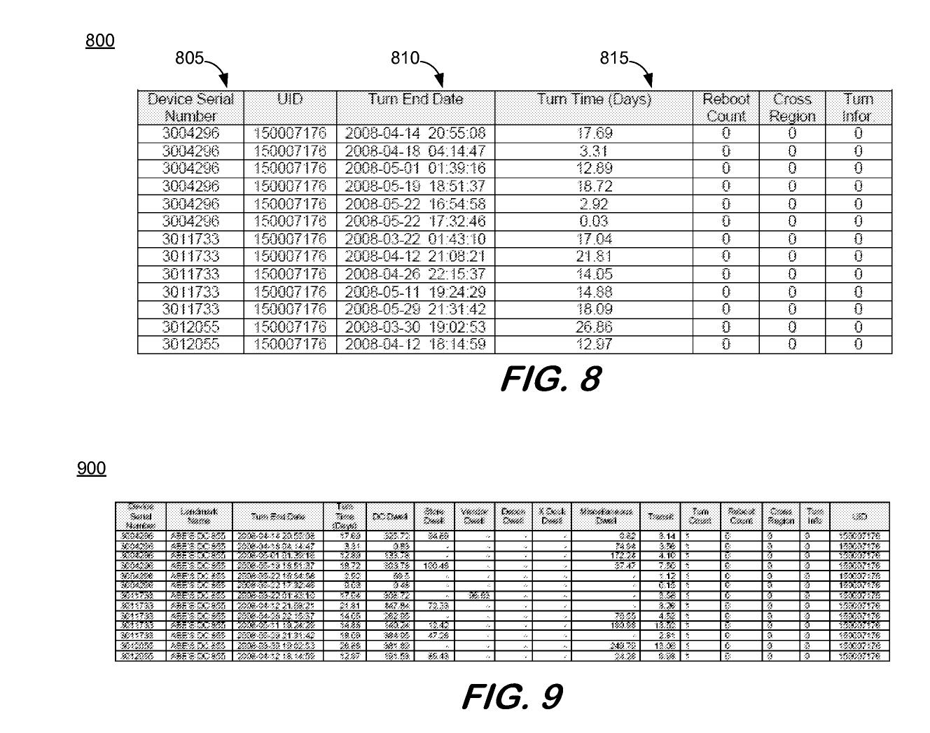

In some embodiments, “turn times” may be organized or structured into tables. FIG. 6 is an illustrative tabular organized listing 600 of turn time related. FIG. 7 is a detailed turn table that includes additional information related to the turn time data included in FIG. 6. Accordingly, the turn table shown in FIG. 6 may be referred to a simplified listing of the turn time data. FIGS. 8 and 9 provide illustrative examples of turn time data that may be obtained for the regional/national department store having a fleet of mobile assets. In particular, the turn time data 800 of FIG. 8 includes a listing for the state-sensing device's serial number at 805 and the corresponding “turn” end date (time and date) at 810 and length of the turn (days) at 815. FIG. 9 provides the turn time related information of FIG. 8 and additional information related to each state-sensing device. For example, turn time data 900 includes fields for DC Dwell, Store Dwell, Vendor Dwell, Decon Dwell, X-Dock Dwell, and Miscellaneous Dwell values, although every parameter may not have a value.

Returning to process 200 of FIG. 2, operation 220 includes calculating a set of metrics for the plurality of mobile assets in fleet 105. In some embodiments, the set of metrics herein are calculated for each location serviced or to be serviced by the one or more mobile assets. By calculating the set of metrics for specific locations, the resulting analytics can provide insight into how to efficiently allocate the resources of the mobile assets relative to the locations. The metrics may be calculated or otherwise determined based on the asset segment data and the turn time data derived from the telematics “raw data”.

In one embodiment, the set of metrics calculated in accordance with the present disclosure includes, for example, a count of unique mobile assets (e.g., trailers), a count of outbound mobile asset occurrences, an average turn time per mobile asset (days), and a number of turns per mobile asset in a given time interval for each location.

The calculation of these metrics provides a reliable and repeatable methodology for determining an optimal pool size for a particular location serviced or to be serviced by the plurality of mobile assets. Operation 225 of FIG. 2 encompasses the determination of the optimal pool size for the fleet of mobile assets for a particular location. In some embodiments, the “optimal” pool size refers to the necessary or required number of mobile assets needed to sufficiently service a particular location. In some embodiments, the optimal pool size may correspond to a minimum number of mobile assets to service a location whereas the optimal pool size may be a certain percentage above a minimum number of mobile assets.

At operation 230, a report may be provided to a user or other entity (person or application, program, device, or service) regarding the determined pool size. The report may be provided in the form of a paper print out, an electronic file, or an audio-visual display. In some embodiments, the report of the optimal pool size may be used to manage the fleet of mobile assets 105.

It is noted that asset segments and turn times are related since, for example, setting target segment times permits a user to set target turn times. When combined with a user's forecasted number of deliveries to be made by the mobile asset fleet, calculating the target turn time will enable the method/system to determine a mobile asset fleet pool size. The determined mobile asset fleet pool size may be to improve efficient management of the mobile assets.

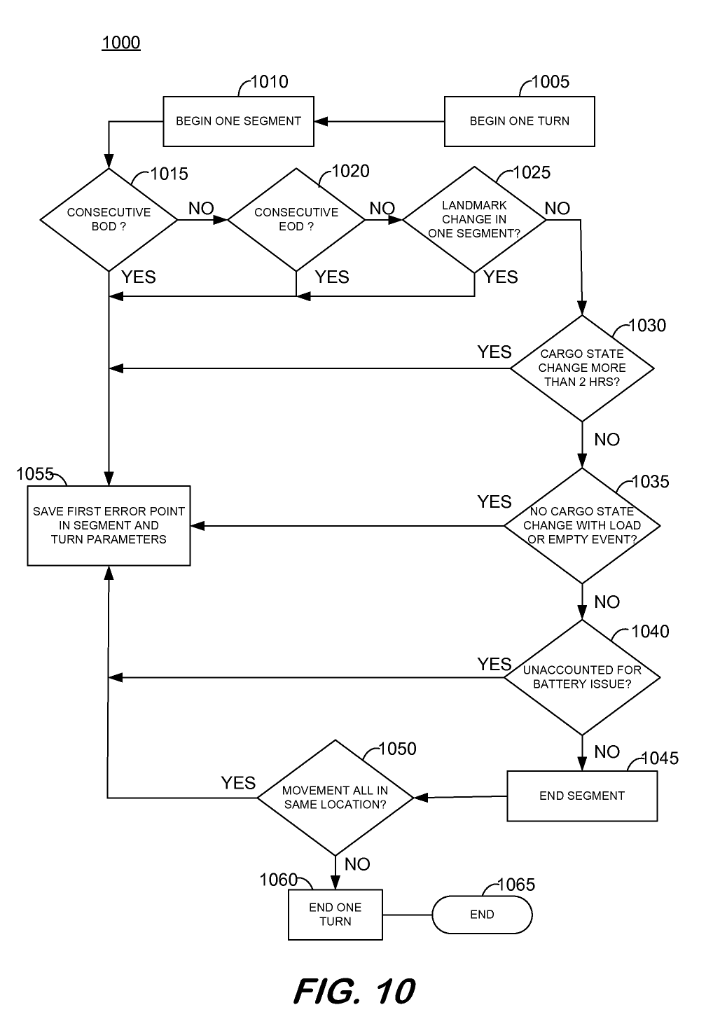

In some embodiments, a mechanism for identifying errors or exception points may be included in the methods and systems herein. FIG. 10 is an illustrative flow diagram of a process to identify errors in data related to, for example, managing a fleet of tractor-trailers. Data reviewed for errors may include asset segment data and turn time data. A first operation 1005 may be initiated with the beginning of a turn or the beginning of a segment at operation 1010. Process 1000 proceeds to determine whether consecutive BOD (beginning of drive) or consecutive EOD (end of drive) indicators are included in the telematics data associated with the tractor-trailers at operations 1015 and 1020. If consecutive BOD or EOD status signals are present in the mobile asset segment and turn data, then an error point is recorded as having occurred since consecutive BOD and EOD states are not expected or reflective or real world transportation. If more than one landmark change occurs in a single segment as determined at operation 1025, then an error is noted at 1055.

In the instance process 1000 proceeds to operation 1030, then a determination is made whether a cargo state change is greater than, for example, two hours. If the determination is a “yes”, then the process proceeds to log an error at operation 1055. Otherwise, process 1000 proceeds to operation 1035 where a determination is made whether a cargo change does not accompany load or empty event. In the event no cargo change occurs with the load or empty event, an error is determined to have occurred and the process proceeds to operation 1055. Otherwise, process 1000 proceeds to operation 1040 where it is determined whether some unaccounted battery (or generally, power related) issue of the state-sensing device has occurred that may have resulted in an error in the segment and turn data. If there is an unaccounted for battery issue, then process 1000 advances to operation 1055 where an error is recorded.

The segment is ended at operation 1045 and process 1000 continues to operation 1050 where it is determined whether some tractor-trailer movement occurred at one location. Such a “movement” would indicate that an error is present in the segment and turn data and the process proceeds to operation 1055. In the event all of the movement did not occur at the same location, then the turn is terminated at operation 1060 and process also ends at 1065.

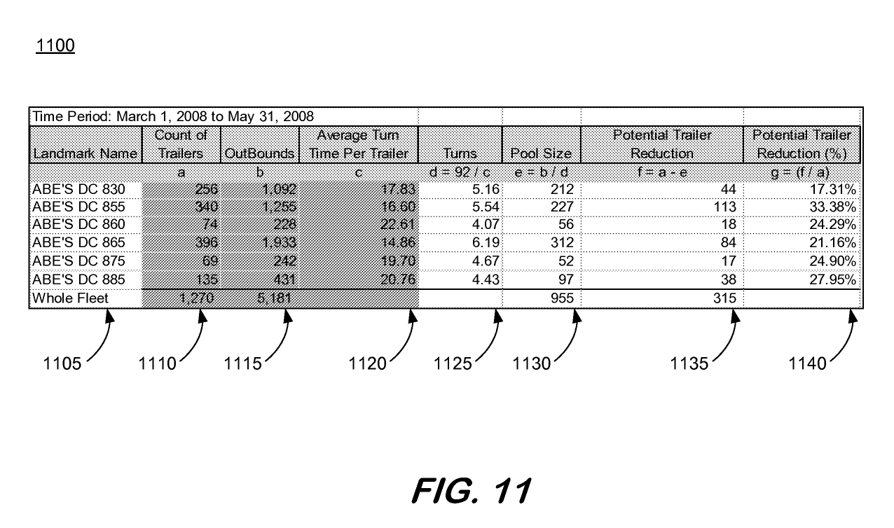

By way of an example and not as a limitation of the present disclosure, an illustrative calculation of an optimal pool size for a fleet of mobile assets (e.g., tractor-trailers) will be discussed with reference to FIG. 11. The data of FIG. 11 is reflective of data collected between Mar. 1, 2008 to May 31, 2008, 92 days. The data of FIG. 11 is only related to the retailer ABE'S Distribution Centers (DC) types of landmarks. This constraint may be beneficial since distribution centers present an opportunity for a fleet manager or other manager to gain improvements based on the location they can most control. It is noted however that other reports may be produced for other time frames and/or landmark types.

The data of columns 1110, 1115, and 1120 include the metrics that form the foundation for the calculation of the optimal (e.g., necessary) pool size to service a DC. For each DC, there is a count of unique trailers that visited the landmark during the given time period (1110), a count of occurrences of trailers outbound (1115), and the average turn time per trailer, in days (1120).

In the current example, the retailer (ABE's) uses a regional delivery system where there is one DC in each region. Thus, each trailer should be associated with only one DC. Accordingly, the count of trailers for the entire trailer fleet is equal to the sum of trailers related to each DC. Referring to the example of FIG. 11, the mobile fleet included 1,270 trailers.

Based on the metrics determined in accordance with the present disclosure, a calculation of the number of turns executed per trailer in the given time period for each DC is executed. The number of turns per trailer is equal to the elapsed time (92 days) divided by the average turn time per trailer in days, as shown at column 1125. For example, for the data of FIG. 11 the number of turns executed in the 92 day period varies from 4.07 turns per trailer to 6.19 turns per trailer.

The minimum number of trailers that should be flowing through each DC in order to meet their demand, with no additional trailers remaining dormant, refers to the optimal pool size. The optimal pool size may be calculated for each DC by taking the count of occurrences of trailers outbound (1115) and dividing it by turns per trailer (1125). Furthermore, a potential reduction in trailers may be calculated and the reduction may be presented in terms trailer numbers (1135) or a percentage (1140).

In the present example, three assumptions have been made to validate the optimal pool size calculation. It is assumed that each DC's fully executes 100% of its orders during the given time frame, all trailers are operational, and the trailers only leave a DC for business purposes. In the instance the DC of FIG. 11 fails to adhere to these assumptions, then the calculated pool size (1130) may have to be altered to compensate for variances.

In some embodiments, methods or processes may include an analysis (e.g., a statistical analysis) of the telematics data. Such an analysis may be provided in an effort to better control the management processes of a fleet of mobile assets. For example, segment data, turn time data, and other metrics based on the asset segment data and the turn time data, etc. may be analyzed for variances. Analysis of the different processes may facilitate identification of those processes that are under control and those processes (if any) that have outlier elements. Controlling of the identified processes that include outlier elements may then be used to gain control of those processes also. Accordingly, process control of given segments, turn times, etc. through statistical analysis may be at least an aspect of the methods and systems herein.

In some yet another embodiment, an identification methodology may be used to determine malfunctioning tracking systems. Analysis of error codes associated with the various types of data discussed and disclosed herein, including variances, outliers, and anomalies and/or trends in such data may be performed to identify malfunctioning tracking and telematics related systems and components.

Each of the methods described above can be performed on a single computer, computer system, microprocessor, etc. In addition, two or more of the steps in each of the methods described above may be performed on two or more different computers, computer systems, microprocessors, etc., some or all of which may be locally or remotely configured. The methods can be implemented in any sort of implementation of computer software, program, sets of instructions, code, or specially designed chips, logic gates, or other hardware structured to directly effect or implement such software, programs, sets of instructions or code. The computer software, program, sets of instructions or code can be storable, writeable, or embodied on any computer usable or readable media or other program storage device or media such as a magnetic medium or optical disk, CD-ROM, DVD, paper tape, hard disk drive, flash or optical memory card, microprocessor, solid state memory device, RAM, EPROM, or ROM.

Although the present disclosure has been described with respect to various embodiments thereof, those skilled in the relevant art will note that various substitutions may be made to those embodiments described herein without departing from the spirit and scope of the present disclosure.

What is claimed is:

1. A computer-implemented method, the method comprising:
receiving asset event data associated with a plurality of mobile assets, the asset event data including information indicative of location status, motion status, and cargo status of the plurality of mobile assets;
determining, by a computer, asset segment data for the plurality of mobile assets based on the asset event data, the asset segment data defined by the asset event data of the plurality of mobile assets during a time interval;
determining, by the computer, turn time data for each of the plurality of mobile assets, the turn time data being based on the asset segment data and a user-defined delivery cycle;
calculating, by the computer, a set of metrics for the plurality of mobile assets based on the asset segment data and the turn time data;
determining, by the computer, an optimal asset pool size for a location to be serviced by the plurality of mobile assets; and
providing an output of the determined optimal asset pool size for the location.

2. The method of claim 1, further comprising:
determining errors in the received asset event data;
storing the asset event data minus the determined errors; and
determining asset segment data for the plurality of mobile assets based on the asset event data minus the determined errors.

3. The method of claim 1, wherein the asset segment data is defined by the location status, the motion status, and the cargo status of the asset event data.

4. The method of claim 1, wherein the time interval is one of the following: an in transit time interval during which the mobile asset is in transit from a one location to another location, an idle time interval during which the mobile asset is stationary at a particular location, and a dormant time interval during which the mobile asset a location status and motion status is not available from the mobile asset.

5. The method of claim 1, further comprising:
determining errors in the asset segment data;
storing the asset segment data minus the determined errors; and
determining the turn time data for the plurality of mobile assets based on the asset segment data minus the determined errors.

6. The method of claim 1, wherein the calculated set of metrics includes a count of unique mobile assets, a count of occurrences of outbound mobile assets, and an average turn time per mobile asset.

7. The method of claim 1, wherein the determined optimal asset pool size for the location is the minimum number of mobile assets required to service the location.

8. The method of claim 1, further comprising storing the asset segment data and the turn time data for the plurality of mobile assets.

9. The method of claim 1, wherein the plurality of mobile assets comprise a fleet.

10. A system for managing mobile assets, the system comprising:
a data source; and
a computer including a processor and in communication with the data source, the computer operable to:
receive asset event data associated with a plurality of mobile assets comprising a fleet, the asset event data including information indicative of location status, motion status, and cargo status of the plurality of mobile assets;
determine asset segment data for the plurality of mobile assets based on the asset event data, the asset segment data defined by the asset event data of the plurality of mobile assets during a time interval;
determine turn time data for each of the plurality of mobile assets, the turn time data being based on the asset segment data and a user-defined delivery cycle;
calculate a set of metrics for the plurality of mobile assets based on the asset segment data and the turn time data;
determine an optimal asset pool size for a location to be serviced by the plurality of mobile assets; and
provide an output of the determined optimal asset pool size for the location.

11. The system of claim 10, where the computer is further operable to:
determine errors in the received asset event data;
store the asset event data minus the determined errors; and
determine asset segment data for the plurality of mobile assets based on the asset event data minus the determined errors.

12. The system of claim 10, wherein the asset segment data is defined by the location status, the motion status, and the cargo status of the asset event data.

13. The system of claim 10, wherein the time interval is one of the following: an in transit time interval during which the mobile asset is in transit from one location to another location, an idle time interval during which the mobile asset is stationary at a particular location, and a dormant time interval during which a location status and a motion status is not available from the mobile asset.

14. The method of claim 10, wherein the processor is further operable to:
determine errors in the asset segment data;
store the asset segment data minus the determined errors; and
determine the turn time data for the plurality of mobile assets based on the asset segment data minus the determined errors.

15. The system of claim 10, wherein the calculated set of metrics includes a count of unique mobile assets, a count of occurrences of outbound mobile assets, and an average turn time per mobile asset.

16. The system of claim 10, wherein the determined optimal asset pool size for the location is the minimum number of mobile assets required to service the location.

17. The system of claim 10, further comprising storing the asset segment data and the turn time data for the plurality of mobile assets.

18. The system of claim 10, wherein the plurality of mobile assets comprises a fleet.
